(19) United States
(12) Patent Application Publication
(10) Pub. No.: US 2008/0251258 A1
(43) Pub. Date: Oct. 16, 2008

(54) Tubing Support Assembly, Vessel And Method Of Deploying Tubing

(76) Inventor: Anthony Stephen Bamford, Montrose (GB)

Correspondence Address: SUGHRUE MION, PLLC, 2100 PENNSYLVANIA AVENUE, N.W., SUITE 800, WASHINGTON, DC, 20037, US

(21) Appl. No.: 11/817,816

(22) PCT Filed: May 17, 2006
(86) PCT No.: PCT/GB06/01822

§ 371 Date: Sep. 5, 2007

(30) Foreign Application Priority Data
May 17, 2005 (GB) 0509993.2

(51) Int. Cl. F16L 1/16

(52) U.S. Cl. 166/355; 166/352

(57) ABSTRACT

There is disclosed a tubing support assembly for supporting tubing utilised in the oil and gas exploration and production industry, a vessel including such a tubing support assembly, and a method of deploying such tubing from a vessel.

In one embodiment, a tubing support assembly (12) is disclosed which includes a tubing support in the form of a tension frame (20) that receives and supports tubing such as a casing riser (14) to be deployed from a drillship (10). The tension frame (20) is movable relative to a deck (22) of the drillship (10) and can be located below a level of the deck (22), to facilitate deployment of the tubing (14) from the drillship (10) to a seabed (37).

The present invention relates to a tubing support assembly, a vessel comprising a tubing support assembly, and to a method of deploying tubing from a vessel. In particular, but not exclusively, the present invention relates to a tubing support assembly for supporting tubing utilised in the oil and gas exploration and production industry, including riser, casing, liner and production tubing; to a vessel comprising such a tubing support assembly; and to a method of deploying such tubing from a vessel.

In the oil and gas exploration and production industry, many oil and gas fields are in offshore environments. In most cases, particularly in deep water environments, access to rock formations bearing well fluids (oil and gas) is achieved using vessels such as semi-submersible rigs, floating production storage and offloading vessels (FPSOs), drill ships and the like. Vessels of this type are typically moored on station using catenary chains or cables, and/or by complex dynamic positioning systems.

As is well known in the art, an offshore well is typically drilled from the seabed utilising a string of drill tubing deployed from surface, and is then lined with a steel casing which extends from a wellhead at seabed level, and which is subsequently cemented in place. A marine riser carrying a blow-out preventer (BOP) is then deployed from surface and secured to the wellhead. The well is then completed by installing production tubing extending from surface through the BOP into the casing and to a location adjacent a producing formation, and well fluids are conveyed to surface through the production tubing.

In the situation where a floating vessel is utilised, various types of tubing require to be deployed from the vessel, and their position relative to the seabed and other downhole equipment must be carefully controlled. In particular, the marine riser must be supported from the vessel during deployment and mating with the wellhead on the seabed and indeed during subsequent production of well fluids.

As the vessel is located at surface, it is subject to external loading including wind, wave, current and tidal loads, and therefore has a tendency to pitch, heave, roll and surge. This loading on the vessel requires to be damped out in order to maintain the position of the marine riser (and other tubing) relative to the wellhead. In particular, it is imperative that the position of the lower part of the riser is known, both during lowering and mating with the wellhead and thereafter, to prevent damage to the riser, the BOP and the wellhead. Also, the riser itself is subject to external loading, particularly tidal/current loads, and the consequent effect on the position of the riser, and thus of the vessel, must be accounted for.

Conventionally, the riser system and indeed other tubing deployed from such vessels have been supported by handling equipment suspended from a derrick on the vessel, thereby placing the riser in tension. The weight and drag of the riser in water is critical to the capacity of the riser to be tensioned, and to the dynamic load capacity of the derrick required to support the riser for a given water depth and met-ocean conditions. Accordingly, the size of the rig or vessel utilised in an offshore environment is often dictated by the diameter of the riser, by virtue of the tensile loads that must be supported. A typical wellhead system may have an external diameter of 18¾″, requiring a riser with an internal dimension of around 19¼″ to allow for the passage of all tools to be run into the wellhead. This requires a consequently large rig or vessel.

In recent years, attempts have been made to reduce drilling costs, through the use of surface BOPs, and by utilising smaller diameter casing as the riser to surface, the aim being to reduce tensile loads applied to the vessel such that smaller mono-hull vessels may be utilised. Additionally, efforts have been made to migrate drilling and subsea intervention equipment to such smaller mono-hull vessels.

However the dynamic weight of the riser and the loads imposed on the derrick or handling tower of such vessels are ultimately critical in determining the suitability of the vessel for this task. Indeed, even where a slimmed down casing riser is utilised, say of 9⅝″ internal diameter, this would require a dynamic load of 400 metric tons to be supported in water depths of 3,000 metres. When the weight of the BOP is considered, a further 200 metric tons of dynamic loads must be supported.

A derrick installed on a mono-hull vessel, required to react loads in the order of 600 tons, requires a large and heavy structure, further compounding the loads already imposed on the vessel. In addition, the stability of the vessel is then greatly and adversely affected, by virtue of high tensile loads being suspended from the top of the derrick; the higher the derrick, the more the vessel stability is compromised. Furthermore, the loads on the derrick legs are alternately compressive and tensile loads, especially when the vessel experiences a pronounced roll. However, most mono-hull vessels are designed to support limited loading on their decks. Generally these load values are quoted in the region of 5 metric tons per square metre, therefore strengthening is required to enable the vessel to support such loads.

Some derrick designs, such as ‘ramrig’ type systems, improve the situation by reacting the riser loads through rams at the deck level, instead of through the derrick structure. However, large dynamic loads are still generated at height and must be distributed on the deck.

It will be appreciated that the above described disadvantages are present not only when running tubing such as riser, but also other types of tubing including casing, liner, production tubing, drill tubing and other tool/tubing strings.

It is amongst the objects of embodiments of the present invention to obviate or mitigate at least one of the foregoing disadvantages.

According to a first aspect of the present invention, there is provided a tubing support assembly for a vessel, the tubing support assembly comprising:

a tubing support adapted to receive and support tubing to be deployed from the vessel, the tubing support being movable relative to the vessel deck and adapted to be located below a level of the vessel deck, to facilitate deployment of the tubing from the vessel.

By providing a tubing support assembly having a tubing support that is adapted to be located below a level of the vessel deck, the load of the tubing can effectively be supported from the vessel deck. This is in contrast with conventional tubing support assemblies such as derricks and ram rigs, where the load of the tubing is supported at a height above the vessel deck, leading to instability and requiring large vessels/rigs, as described above.

It will be understood that vessels of the type used in the oil and gas exploration and production industry typically include a rig and a rig floor provided in a deck of the vessel. The rig floor is the work area in which a rig crew conducts operations, including the adding and removing of tubing to and from tubing strings used in downhole operations. Such tubing strings are deployed from the vessel through the rig floor. Accordingly, the tubing support may be adapted to be located below a rig floor of the vessel.

The tubing may be any one of the various types utilised in the oil and gas exploration and production industry, but in particular may comprise a riser. It will be understood that such tubing is typically made up from lengths of interconnected tubing sections which are coupled together using threaded joints.

The tubing support assembly may be a tubing tensioner assembly, for supporting the tubing and placing the tubing under tension. It will be understood that this may be achieved when the tubing is deployed from and thus suspended from the vessel.

Preferably, the tubing support is movable relative to the vessel deck within a passage extending through the vessel deck. The passage may be a moonpool. It will be understood that many vessels used in the oil and gas exploration and production industry, including drillships, floating storage and offloading vessels (FSOs), FPSOs, semi-submersible rigs and other floating facilities include a passage through the vessel deck through which tubing and other equipment is deployed from the vessel. In some vessels, particularly drillships, this passage is referred to as a moonpool. The tubing support may be mounted for movement through the passage, and may be movable between a position within the passage and a position outside the passage, to facilitate deployment of the tubing. It will be understood that the tubing support may be moved to position where the support is located above the surface of the water, or to a position where the tubing support is submerged.

It will also be understood that, in an alternative, the tubing support may be movable relative to the vessel deck over a side, bow or stern of the vessel, rather than within such a passage, and thus the tubing support may be adapted to be deployed overboard from the side, bow or stern of the vessel.

The tubing support assembly may be adapted to compensate for relative movement between the vessel and the tubing. This may facilitate control of the position of the tubing relative to the seabed in the location where the tubing is to be deployed, even when the vessel is moving relative to the seabed under external wind, wave, current and/or tidal loading, and when relative movement between the tubing and the vessel occurs due to current and/or tidal loading on the tubing. This is of particular importance when the tubing approaches the seabed, to ensure that the tubing (and any related equipment carried by the tubing) is not damaged through an uncontrolled impact with the seabed. Whilst reference is made herein to the seabed in the location where the tubing is to be deployed, it will be understood that the tubing may be deployed in a river, lake or the like and thus that it may be necessary to control movement of the tubing relative to the riverbed, lakebed or the like.

The tubing support assembly may be adapted to be operated in an active compensation mode, where the tubing is raised and lowered relative to the vessel by the tubing support, in order to control movement of the tubing relative to the seabed. In particular, it is desired to control the location of a lower end of the tubing relative to the seabed. The tubing support assembly may be adapted to be operated in the active compensation mode prior to location of the tubing on or in the seabed.

The tubing support assembly may be adapted to be operated in a passive compensation mode, where movement of the vessel relative to the seabed is compensated for by permitting relative movement between the vessel and the tubing. The tubing support assembly may be adapted to be operated in the passive compensation mode following location of the tubing on or in the seabed.

In the active compensation mode, power usage is relatively high, due to a requirement to raise the entire tubing string at times when the vessel is descending relative to the seabed. In contrast, in the passive compensation mode, it is necessary only to damp out movement of the vessel relative to the seabed by permitting the vessel to move up and down relative to the tubing, without a requirement to raise and lower the tubing.

It will be understood that, during deployment of the tubing from the vessel, the tubing is made up at surface and deployed from the vessel using the tubing support. Initially, it is not necessary to compensate for movement of the vessel relative to the seabed and the tubing is allowed to rise and fall (relative to the seabed) with the vessel. As the tubing is extended by adding further lengths of tubing at surface, the tubing is brought to a position where it comes near to the seabed. At this stage, the tubing support assembly may be adapted to be switched to active compensation mode, to control the position of the tubing relative to the seabed. Following location of the tubing on or in the seabed, the tubing support assembly may then be switched into passive compensation mode.

The tubing support may be adapted to releasably receive/engage and support the tubing. As will be described below, this may facilitate deployment of the tubing from the vessel. The tubing support may be a primary tubing support and the tubing support assembly may comprise a secondary tubing support which may be adapted to selectively support the tubing to facilitate deployment of the tubing from the vessel. The secondary tubing support may be provided on or in the deck and may be adapted to support the tubing when the primary tubing support is released from the tubing.

The tubing support may comprise a tubing support device for receiving and supporting the tubing, and the tubing support device may be adapted to releasably engage the tubing. The tubing support device may be a tubing gripping device of the type disclosed in U.S. Pat. No. 2,062,628 to Yannetta or a ball gripping mechanism of the type disclosed in U.S. Pat. No. 2,182,797 to Dillon, the disclosures of which are incorporated herein by way of reference. However, alternative gripping devices such as releasable slips may be utilised. Where the tubing support assembly comprises primary and secondary tubing supports, the secondary tubing support may also comprise such a tubing support device.

The tubing support assembly may comprise a support structure having a further tubing support, and the support structure may be adapted to be provided on the vessel deck. The further tubing support may be adapted to support a part of the load of the tubing, to assist in make-up and deployment of the tubing from the vessel. The support structure may be a derrick and the further tubing support may be an elevator/compensator provided on the derrick. Alternatively, the support structure may be a ram rig and the further tubing support may be a travelling yoke of the ram rig. The elevator/yoke may be adapted to be utilised for assembling the tubing and thus for lifting and supporting lengths of tubing to be added to the tubing string.

The tubing support assembly may be adapted to selectively share the load of the tubing between the tubing support which is adapted to be located below a level of the vessel deck (which may be a primary tubing support) and the further tubing support on the support structure. In order to minimise loads at height above the vessel deck, the further tubing support may be adapted to bear only a relatively small portion of the load of the tubing, say up to 10% of the total load, with the remaining, primary part of the load borne by the primary tubing support.

The tubing support assembly may comprise a tubing support control system, for controlling movement of the tubing support relative to the vessel deck. The control system may serve for controlling relative movement between the tubing and the vessel. In particular, where the tubing support assembly is adapted to be operated in an active compensation mode, the control system may be adapted to control raising and lowering of the tubing support relative to the vessel deck.

The control system may comprise at least one winch coupled to the tubing support by a winch cable, for raising and lowering the tubing support relative to the vessel deck. It will be understood that the winch may control raising and lowering of the tubing support by reeling in and paying out the winch cable.

The winch may carry an operative length of winch cable, the operative length being determined by the maximum permitted or desired spacing (depth) of the tubing support relative to the vessel deck. The winch may carry sufficient cable to permit changeover of the operative length following a determined number of cycles of reeling and unreeling of the winch cable and/or period of operation using the operative length of cable. In this fashion, the winch cable can be changed over when it has reached the end of its working life, without requiring the tubing assembly to be released from the tubing support.

The tubing support assembly may comprise at least one further winch coupled to the tubing support. In an embodiment of the invention, the tubing support assembly may comprise an input winch for feeding additional cable and an output winch for receiving spent cable during changeover of the operative length of the winch cable. The output winch may be adapted to control movement of the tubing support, and may therefore be adapted to raise and lower the tubing support. Alternatively or in addition, the input and output winches may be adapted to together control movement of the tubing support.

Where the tubing support assembly comprises a primary tubing support and a further tubing support (on a derrick/ramrig), the control system may be adapted to control the relative portions of the tubing load supported by the respective tubing support.

The tubing support assembly may comprise at least one tubing tensioning device for accommodating movement of the vessel relative to the seabed. When the tubing support assembly is in the passive compensation mode, the at least one tubing tensioning device may be activated and may thereby compensate for movement of the vessel relative to the seabed. The winch may be locked or otherwise prevented from paying out or reeling in cable when the assembly is in the passive mode, such that movement of the vessel relative to the seabed is taken up by the tubing tensioning device. The at least one tubing tensioning device may be adapted to maintain tension in the tubing substantially constant, thereby damping out effects which movement of the vessel would otherwise have upon the tension in the tubing, and thus upon the position of the tubing relative to the seabed. When the tubing support assembly is in the active compensation mode, the at least one tubing tensioning device may also optionally be activated, and may compensate for movement of the vessel relative to the seabed in conjunction with the winch, in order, for example, to achieve a controlled lowering of the tubing relative to the vessel whilst compensating for movement of the vessel relative to the seabed.

The at least one tubing tensioning device may be fluid actuated or operated and, in a particular embodiment, may be hydraulically operated. Where the tubing support assembly comprises a winch coupled to the tubing support by a winch cable, the winch cable may extend from the winch to the tubing tensioning device and from the tubing tensioning device to the tubing support. The winch may be adapted to be locked (to prevent rotation and thus pay-out or reel-in of cable) during operation of the tubing tensioning device, enabling the tubing tensioning device to act to move the tubing support, and thus to raise and lower the tubing support relative to the vessel.

The at least one tubing tensioning device may be extendable and may be adapted to take-up and pay-out winch cable in order to accommodate movement of the vessel relative to the tubing support. The at least one tubing tensioning device may comprise a piston mounted in a cylinder, and the winch cable may extend around a first sheave or the like provided on one of the cylinder and the piston and around at least one further second sheave or the like provided on the other one of the cylinder and the piston. In this fashion, movement of the piston within the cylinder may vary a distance between the sheaves, thereby taking up or paying out the winch cable. This may facilitate relative raising and lowering of the tubing support. The tubing tensioning device may comprise a plurality of sets of sheaves, each set comprising first, upper and second, lower sheaves. The winch cable may be adapted to be passed over or around the sheaves in the sets and to the tubing support.

The control system may comprise a hydraulic control arrangement for controlling the flow of fluid into and out of the piston of the at least one tubing tensioning device. In embodiments of the invention, the piston may comprise first and second opposed piston faces, and movement of the piston within the cylinder may be achieved by controlling the pressure of fluid that the first and second piston faces are exposed to.

The hydraulic control arrangement may comprise a first pressure accumulator coupled to the cylinder and associated with the first piston face, and a second pressure accumulator coupled to the cylinder and associated with the second piston face. In use, the piston may be adapted to be moved by creating a pressure differential across the piston, by exposing one of the piston faces to an elevated fluid pressure relative to the pressure of fluid that the other piston face is exposed to, in response to a movement of the vessel relative to the tubing. This may be achieved by connecting the tubing support to the tensioning device such that during an upward movement of the vessel relative to the seabed, the piston is moved down to expel fluid from one end of the cylinder. Fluid expelled from the cylinder during such movement of the piston may be stored in the respective accumulator, for use during a return movement of the piston. It will therefore be understood that the accumulators may be utilised to store energy by maintaining pressure of fluid bled from the cylinder.

In alternative embodiments, when the tubing support assembly is in the passive compensation mode, the winch may be utilised to compensate for movement of the vessel relative to the seabed. The winch may be coupled to a fluid driven motor, and the control system may comprise a hydraulic control device for controlling the flow of fluid to and thus operation of the motor for rotating and driving the winch in the passive compensation mode. The motor may be adapted to be rotated in a clockwise or anticlockwise direction according to whether the winch is required to reel-in or pay-out cable, to accommodate movement of the vessel relative to the seabed.

Preferably, the tubing support comprises a frame or platform in which the tubing is received. The tubing support assembly may comprise a guide or leader for guiding the winch cable and for preventing the cable from coming into contact with a wall or walls of the passage when the tubing support is moved to a position outside the passage. The guide may be adapted to be located at or towards a lower end of the passage, and may comprise one or more optionally retractable locking members for locking the guide at or towards the lower end. The guide may be releasably mounted on the tubing support, and may thus be adapted to be carried by and supported on the tubing support when the tubing support is lowered down through the passage.

According to a second aspect of the present invention, there is provided a vessel comprising:

a vessel deck; and
a tubing support assembly, the tubing support assembly comprising a tubing support adapted to receive and support tubing to be deployed from the vessel through the vessel deck, the tubing support being movable relative to the vessel deck and adapted to be located below a level of the vessel deck, to facilitate deployment of the tubing from the vessel.

Further features of the tubing support assembly of the vessel are defined above in relation to the first aspect of the present invention.

According to a third aspect of the present invention, there is provided a method of deploying tubing from a vessel, the method comprising the steps of:

supporting tubing to be deployed from the vessel on a tubing support of a tubing support assembly; and
moving the tubing support relative to a deck of the vessel to a location below a level of the vessel deck, to thereby deploy the tubing from the vessel through the vessel deck.

The tubing support may be moved to a location below a rig floor of the vessel, to deploy the tubing.

The method may comprise using the tubing support to place the tubing in tension.

The tubing support may be moved relative to the vessel deck within a passage extending through the vessel deck, which may be a moonpool. The tubing support may be moved through the passage between a position where the support is located within the passage, and a position outside the passage, to facilitate deployment of the tubing. Furthermore, the tubing support may be moved to position where the support is located above the surface of the water, or to a position where the tubing support is submerged.

The method may comprise using the tubing support assembly to compensate for relative movement between the vessel and the tubing. The tubing support assembly may be selectively operated in an active compensation mode, where the tubing is raised and lowered relative to the vessel by the tubing support, in order to control movement of the tubing relative to the seabed. The tubing support assembly may be operated in the active compensation mode prior to location of the tubing on or in the seabed.

The tubing support assembly may be selectively operated in a passive compensation mode, where movement of the vessel relative to the seabed is compensated for by permitting relative movement between the vessel and the tubing. The tubing support assembly may be operated in the passive compensation mode following location of the tubing on or in the seabed.

During deployment of the tubing from the vessel, the tubing may be made up at surface and deployed from the vessel using the tubing support. Initially, it may not be necessary to compensate for movement of the vessel relative to the seabed and the tubing is allowed to rise and fall (relative to the seabed) with the vessel. As the tubing is extended by adding further lengths of tubing at surface, the tubing may be brought to a position where it comes near to the seabed. At this stage, the tubing support assembly may be switched to active compensation mode, to control the position of the tubing relative to the seabed. Following location of the tubing on or in the seabed, the tubing support assembly may be switched into passive compensation mode.

The tubing support may releasably receive/engage and support the tubing. The method may comprise providing primary and secondary tubing supports, each for selectively supporting the tubing, to facilitate deployment of the tubing from the vessel. The secondary tubing support may be operated to support the tubing when the primary tubing support is released.

The method may comprise providing a support structure having a further tubing support, and the support structure may be on the vessel deck. The further tubing support may be used to selectively support a part of the load of the tubing, to assist in make-up and deployment of the tubing from the vessel. The load of the tubing may be shared between the tubing support which is moved to the location below a level of the vessel deck (the primary tubing support) and the further tubing support on the support structure, which may be a derrick or ramrig. The further tubing support may bear a portion of the load of the tubing in an amount of up to 10% of the total load, with the remaining, primary part of the load borne by the primary tubing support.

Movement of the tubing support relative to the vessel deck may be controlled by a control system which, when the tubing support assembly is in the active compensation mode, controls raising and lowering of the tubing support relative to the vessel deck. The control system may control at least one winch coupled to the tubing support by a winch cable, for thereby raising and lowering the tubing support relative to the vessel deck.

The method may comprise changing-over an operative length of winch cable following a determined number of cycles of reeling and unreeling of the winch cable and/or period of operation using the operative length of cable. The method may comprise feeding additional cable from an input winch, and receiving spent cable-on an output winch, during changeover of the operative length of the winch cable. The output winch may control movement of the tubing support, and may therefore raise and lower the tubing support. Alternatively or in addition, the input and output winches may together control movement of the tubing support.

The method may comprise using an at least one tubing tensioning device to accommodate movement of the vessel relative to the seabed. When the tubing support assembly is in the passive compensation mode, the at least one tubing tensioning device may be activated and may thereby compensate for movement of the vessel relative to the seabed. The winch may be locked or otherwise prevented from paying out or reeling in cable when the assembly is in the passive mode, such that movement of the vessel relative to the seabed is taken up by the tubing tensioning device. Tension in the tubing may be maintained substantially constant using the at least one tubing tensioning device, thereby damping out effects which movement of the vessel would otherwise have upon the tension in the tubing, and thus upon the position of the tubing relative to the seabed. When the tubing support assembly is in the active compensation mode, the at least one tubing tensioning device may also optionally be activated, and may compensate for movement of the vessel relative to the seabed in conjunction with the winch.

In a further aspect of the invention, there is provided a load sharing riser tensioning system that can run multiple joints or lengths of riser, casing and any other tubular from the vessel to the seafloor and below, where the load is shared between the riser tensioners and the derrick handling equipment.

In a still further aspect of the invention, there is provided a load sharing riser tensioning system that uses a remotely operated and released gripping device that can be operated underwater.

In a still further aspect of the invention, there is provided a remotely operated gripping device that opens up or otherwise releases to enable it to be pulled back over the top of the riser, casing or other tubular being run.

In a still further aspect of the invention, there is provided a load sharing riser tensioning system that provides for two lines or cables to be tensioned on one single winch drum that can travel back and forth axially to spool the lines or cables on the winch drum.

In a still further aspect of the invention, there is provided a load sharing riser tensioning system where the relative magnitude of load shared between the load sharing riser tensioners and the derrick hoisting equipment can be adjusted from the operators' (driller's) control position.

In a still further aspect of the invention, there is provided a load sharing riser tensioning system that can be controlled from the operators' (drillers') control position so as to operate automatically and simultaneously with the derrick hoisting equipment or separately depending on the operation being performed.

Embodiments of the present invention will now be described, by way of example only, with reference to the accompanying drawings, in which:

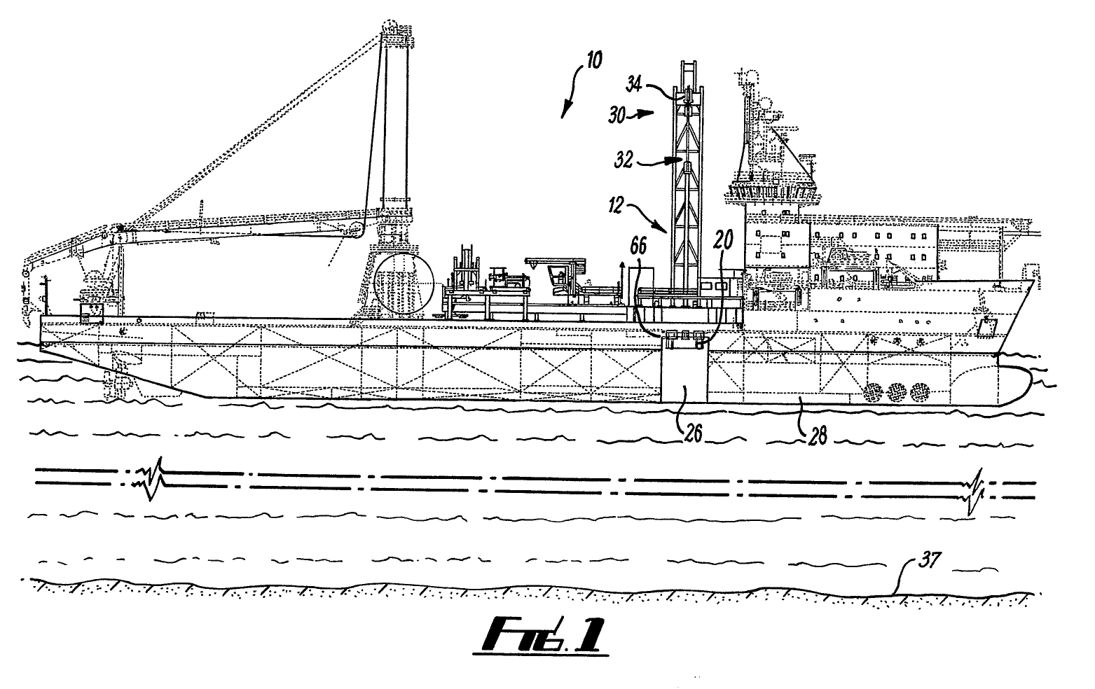

FIG. 1 is a side view of a vessel, including a tubing support assembly, in accordance with an embodiment of the present invention;

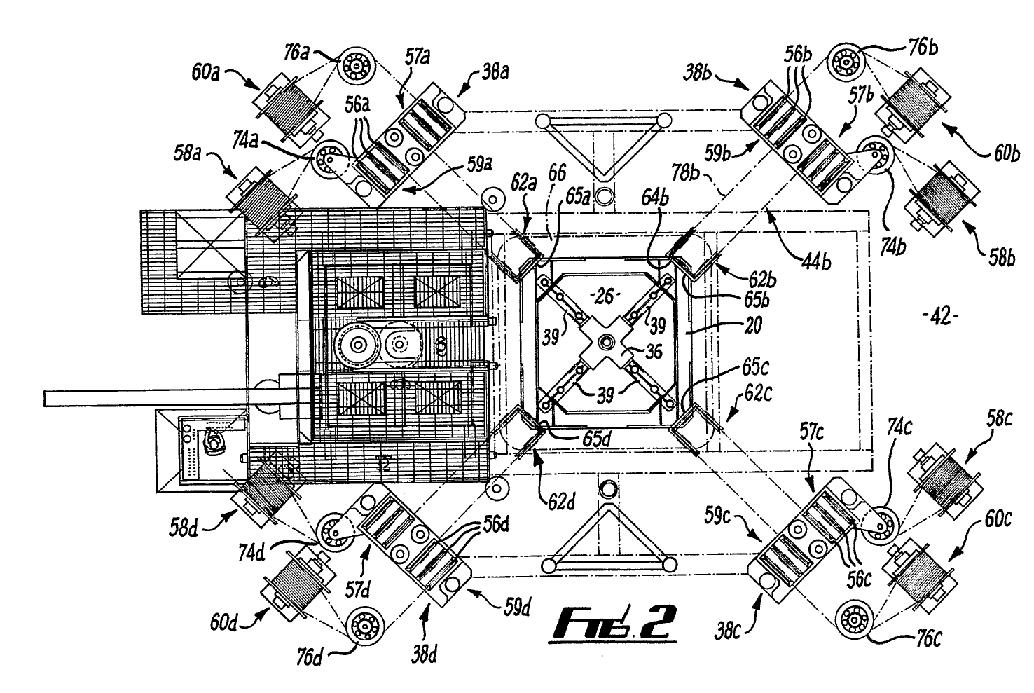

FIG. 2 is an enlarged plan view of the tubing support assembly shown in FIG. 1;

FIGS. 3 to 5 are enlarged schematic side views illustrating the tubing support assembly of FIG. 1 in use, during the deployment of a tubing string from the vessel;

FIG. 6 is an enlarged, schematic side view of a tubing tensioning device forming part of the tubing support assembly of FIG. 1;

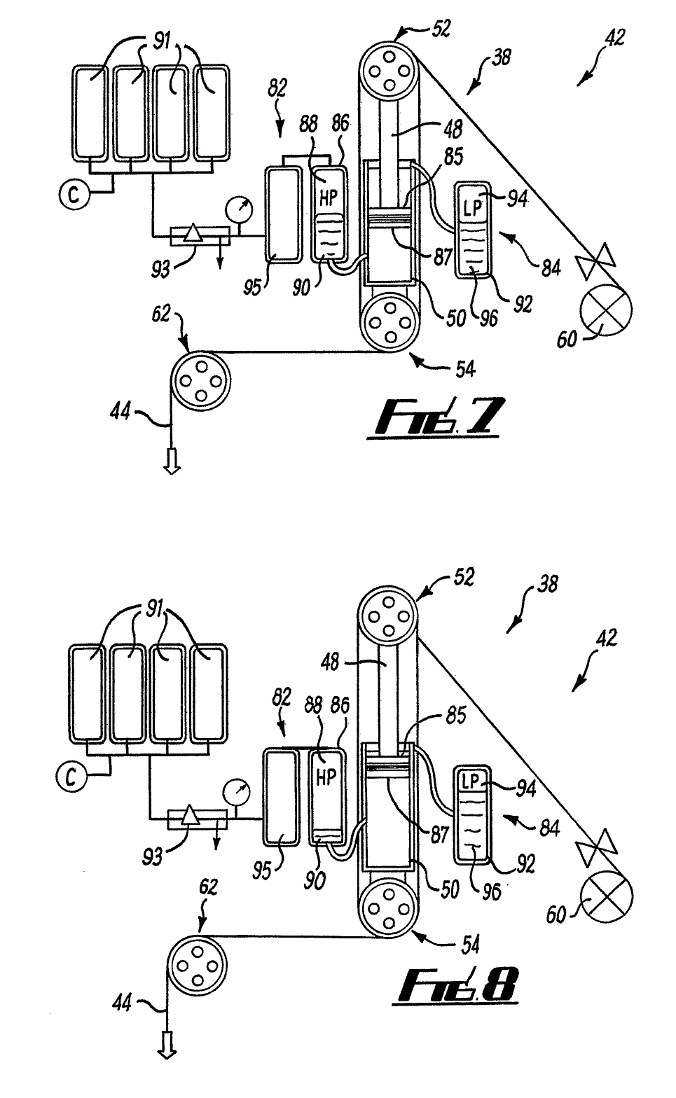

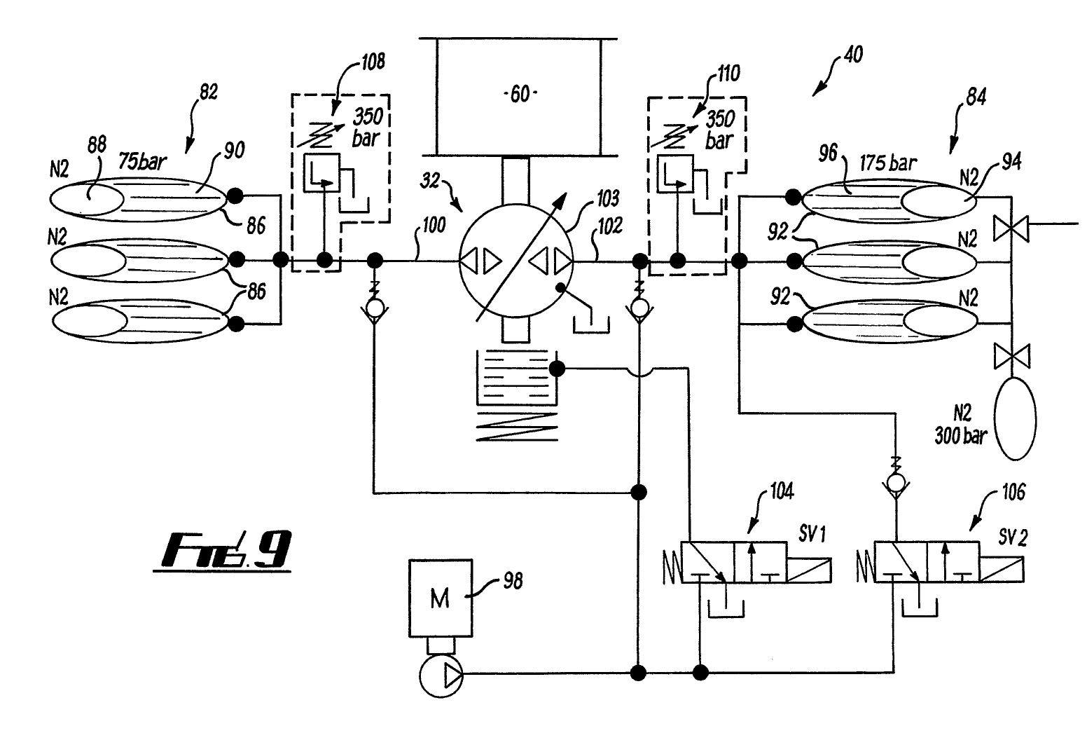

FIGS. 7 and 8 are operative schematic views of part of a control system which forms part of the tubing support assembly of FIG. 1, also showing the tensioning device; and

FIG. 9 is an operative schematic view of part of an alternative control system.

Turning firstly to FIG. 1, there is shown a side view of a vessel 10 including a tubing support assembly in accordance with an embodiment of the present invention, the tubing support assembly indicated generally by reference numeral 12. In the illustrated embodiment, the vessel 10 takes the form of a drillship, but it will be understood that the vessel may equally be an FSO, FPSO, a semi-submersible rig or indeed any other suitable floating facility used in the oil and gas exploration and production industry.

The tubing support assembly 12 is shown in more detail in FIG. 2, which is an enlarged plan view of the tubing support assembly, and in FIGS. 3 to 5, which are enlarged schematic side views illustrating the tubing support assembly 12 in use, during the deployment of a tubing string 14 from the drillship 10. The tubing string 14 is typically made-up from tubing sections 16 coupled together end-to-end using threaded connections 18. As will be appreciated by persons skilled in the art, the tubing string 14 may be any one of the various types of tubing utilised in the oil and gas exploration and production industry, including riser, casing, conductor, liner, drill tubing or production tubing, or even tubing for forming a pipeline. However, in the illustrated embodiment, the tubing string 14 takes the form of a casing riser.

The tubing support assembly 12 generally comprises a tubing support in the form of a tension frame 20, which receives and supports the casing riser 14 to be deployed from the drillship 10. The tension frame 20 is movable relative to a deck 22 of the drillship 10, and in particular is movable relative to a rig floor 24 of the deck 22. As will be described in more detail below, the tension frame 16 can be located at a level below the vessel deck 22, to facilitate deployment of the tubing from the vessel.

As shown particularly in FIGS. 3 to 5, the casing riser 14 is made up on the rig floor 24 and deployed from the drillship 10 through a moonpool 26, which extends through a hull 28 of the drillship. The casing riser may be constructed as part of a procedure for drilling a subsea well of the type disclosed in the Applicant's International Patent Application No. PCT/GB2005/002885 (published as WO2006/010906), the disclosure of which is incorporated herein by way of reference. However, as discussed above, it will be understood that the principles of the present invention apply in relation to the deployment of a wide range of different types of tubing used in the industry.

The support assembly 12 is shown in FIG. 3 located within the moonpool 26 with the casing riser 14 suspended from the rig floor 24 by releasable slips (not shown) or the like. Thus in FIG. 3, the load of the casing riser 14 and any associated equipment coupled to the casing riser sections 16 is supported from the rig floor 24. As discussed above, the casing riser 14 is made-up from interconnected casing riser sections 16, and these sections 16 are indicated with a letter suffix. The lowermost section 16 is indicated by the suffix ‘a’, with subsequent, upper sections denoted ‘b’, ‘c’ etc. Thus an uppermost section 16 to be coupled to the section 16b protruding through the rig floor 24, as shown in FIG. 3, is denoted by the suffix ‘c’.

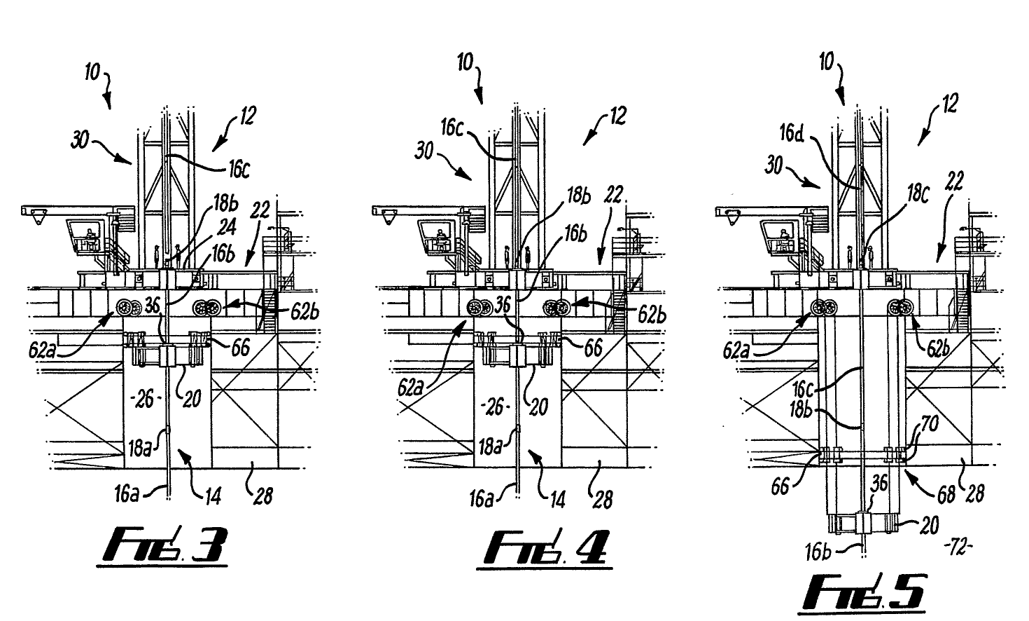

The casing section 16c is suspended from a support structure in the form of a ramrig 30 on the drillship 10, which is of a type known in the art. The ramrig 30 includes a further tubing support in the form of an extendable ram assembly 32 (FIG. 1), which carries a travelling yoke 34 at an upper end from which the casing riser section 16c is suspended. The casing riser section 16c is picked up by the yoke 34, raised to the vertical and then lowered and connected to section 16b using a connection 18b, in a known fashion, and as shown in FIG. 4. A gripping device 36 provided on the tension frame 20 is then activated, to grip and support the casing riser string 14, and the slips at the rig floor 24 are subsequently released. Suitable gripping devices include that disclosed in U.S. Pat. No. 2,062,628 to Yannetta and in U.S. Pat. No. 2,182,797 to Dillon, the disclosures of which are incorporated herein by way of reference. The gripping device 36 is mounted on arms 39, which are themselves pivotally mounted on the frame 20, so that the arms may be retracted from the position shown in FIG. 2. This enables passage of larger items such as a BOP.

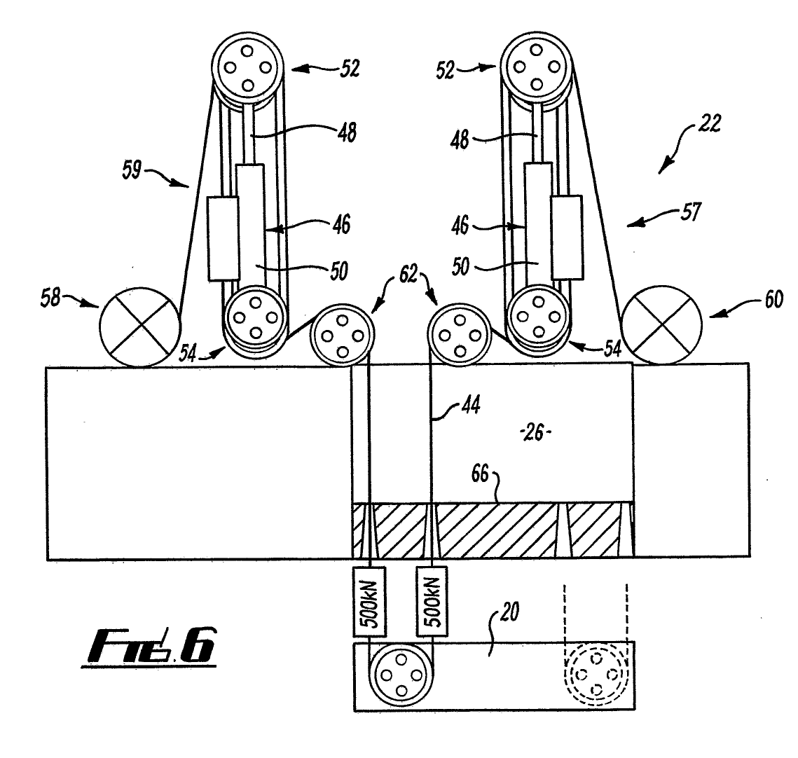

Following activation of the gripping device 36, the tension frame 20 is lowered down through the moonpool 26 by the distance of one casing riser section, as shown in FIG. 5. It will be appreciated, however, that the tension frame 20 may be lowered by a greater distance, for example, the length of two casing riser sections. Indeed, in the illustrated embodiment, the height of the ramrig 30 is such that two sections 16c and 16d of casing riser may be made-up to the riser string 14 and lowered into the moonpool in a single procedure, if desired. Thus the tension frame 20 may travel the distance of two (or more) casing riser sections.

During this deployment of the casing riser string 14, the load of the string 14 is optionally supported in part by the ramrig 30 and in part by the tension frame 20. Typically, the load is supported in a ratio of up to 10% (maximum) by the ramrig 30 and at least 90% by the tension frame 20. In this fashion, only a relatively small portion of the total load is supported at height above the deck 22, from the ramrig 30, with the majority of the load effectively supported from the level of the deck 22, through the support arrangement provided for the tension frame 20.

Following deployment of the casing riser section 16b to the position shown in FIG. 5, the riser string 14 is once-again supported from the rig floor 24, and the gripping device 36 on the tension frame 20 is deactivated to release the riser string 14. This is achieved by supplying a control signal to the gripping device 36, such as an acoustic signal. The tension frame 20 is then returned or ‘stripped-back’ along the riser string 14 up the moonpool 26 towards the position shown in FIG. 3, where the tension frame is ready to receive and grip a subsequent riser casing section 16 in the fashion described above. This procedure is repeated as necessary to extend the casing riser 14 and thus to deploy the riser 14 towards a seabed 37 (FIG. 1); it will be understood that the principles of the present invention may be applied when deploying tubing in water of great depth, say up to 3000 m or more.

Initially, during deployment of the riser string 14 from the drillship 10, the location of a lower end of the string 14 relative to the seabed 37 is not required to be monitored. Thus movement of the riser string 14 relative to the seabed, due to external wind, wave, current and tidal loads on the vessel 10 (causing consequent pitch, heave, roll and surge) does not require to be damped out, and the string 14 moves with the drillship 10. However, as the riser string 14 is extended and the string approaches the seabed 37, it is necessary to monitor and control the location of the string 14 relative to the seabed, in order to avoid damage to the casing riser string. To achieve this, the tubing support assembly 12 is switched into an ‘active’ compensation mode, in which the string 14 is lowered in a controlled fashion towards the seabed 37, where a location of the lowermost end of the riser string relative to the seabed is known and controlled (within prescribed tolerances). Thus, for example, where the riser string 14 carries a conductor (not shown) at a lower end, following the teachings of PCT/GB2005/002885, the conductor may be lowered at a controlled rate, and jetted into the seabed 37 in a controlled fashion.

In the active compensation mode, the support assembly 12 effectively raises and lowers the entire riser string 14 as the drillship 10 moves under external loading. For example, as the vessel 10 descends towards the seabed 37, the support assembly 12 raises the riser string 14 to maintain its position relative to the seabed 37, and vice-versa.

Following location of the lowermost end of the riser string 14 in the seabed, the tubing support assembly 12 is switched into a ‘passive’ compensation mode, in which movement of the drillship 10, relative to the casing riser string 14 (which now provides a fixed point of reference) is damped out. In contrast to active mode, in the passive mode of operation, it is only necessary to take up relative movement between the drillship 10 and the riser string 14. The power usage of the tubing support assembly 12 in the passive mode is considerably less than in the passive mode. For example and as described above, where a slimmed down casing riser string 14 of, say, 9⅝″ internal diameter is utilised, this would require a dynamic load of 400 metric tons to be supported from the drillship 10 in water depths of 3,000 metres. If a BOP (not shown) is coupled to the string 14 during active compensation, an extra load of around 200 metric tons must be supported. The support assembly 12 therefore requires to support and thus raise/lower loads of up to 600 tons.

The detailed structure and operation of the tubing support assembly 12 will now be described in more detail, with reference also to FIGS. 6 and 7. FIG. 6 is an enlarged, schematic view illustrating a tubing tensioning device 38 forming part of the tubing support assembly 12. FIG. 7 is an operative schematic of part of a control system 40 which also forms part of the tubing support assembly 12.

As best shown in FIG. 2, the tubing support assembly 12 includes four tubing tensioning devices 38a to 38d, each of which takes the form of a hydraulic tensioner. The tensioners 38 are provided on a sub-deck 42, below the rig floor 24, and are spaced around the moonpool 26. Each tensioner 38 is connected to the tension frame 20 via respective winch cables 44, and includes a hydraulic ram 46 (FIG. 6) having a piston 48 which is movable within a cylinder 50. The tensioners also include an upper set of sheaves 52 and a lower set of sheaves 54, each set 52, 54 having six individual sheaves 56; a first three sheaves 56 provided on one side 57 of the ram 46 and a further three on the other side 59 of the ram 46, as best shown in FIG. 2. For ease of illustration, the two sides 57 and 59 of the ram 46 are shown separately in FIG. 6. As will be described in more detail below, the sheaves 56 on the two sides 57, 59 of the ram 46 serve for paying out and reeling in the winch cable 44 in a closed-loop arrangement.

In use of the support assembly 12, the pistons 48 of the rams 46 are extended and retracted within the cylinders 50 to respectively lengthen and shorten a distance between the upper and lower sheave sets 52 and 54, to thereby account for movement of the drillship 10 relative to the riser string 14 during passive compensation. However, as will be described, the tensioners 38 may also be used during active compensation.

The tubing support assembly 12 also comprises a number of winches spaced around the moonpool 26, two associated with each tensioner 38 and comprising an input winch 58 and an output winch 60. The input winches 58 are associated with the sheaves 56 in the lower sheave sets 54 provided on the side 57 of the rams 46, whilst the output winches 60 are associated with the sheaves 56 in the lower sheave sets 54 provided on the other side 59 of the rams 46.

A turn-down sheave assembly 62 is provided at each corner of the moonpool 26, one associated with each tensioner 38 and the corresponding winches 58, 60. Support sheaves 64 are provided at each corner of the tension frame 20, each one associated with one of the turn-down sheave assemblies 62. As will be described below, the support sheaves 64 provide a support for the winch cables 44 such that the tension frame 20 (and thus the casing riser string 14) may be supported from the drillship 10. A leader frame 66 is provided above the tension frame 20, and is also movable within the moonpool 26. The leader frame 66 acts as a guide for the winch cables 44 within the moonpool 26 to, in use, prevent the winch cables coming into contact with the walls of the moonpool 26 and thus chaffing over time. The leader frame is supported on and thus carried by the tension frame during lowering, until such time as the leader frame 66 reaches the bottom 68 of the moonpool 26, whereupon the leader frame is locked in position. This is achieved by an arrangement of locking rollers 70 which are biased to snap-out or are actuated to move out into engagement with a locking profile such as a channel (not shown) in the wall of the moonpool 26. As shown in FIG. 5, the tension frame 20 optionally passes out of the moonpool 26 and into the open water 72. The support sheaves 64 are articulated and thus fixed on a rotatable mounting 65, to allow for misalignment between the tension frame 20 and the leader frame 66, due to external loading (such as tidal forces) on the tension frame 20.

The relationship between the input and output winches 58/60, the tensioners 38 and the tension frame 20 will now be described. The input winches 58 feed winch cables 44 into the tensioners 38 over horizontal input sheaves 74, which enable a high fleet angle to be provided. The cable 44 is then fed up and down over the six sheaves in the upper and lower sheave sets 52 and 54 provided on the sides 57 of the rams 46, and from there over the turn-down sheave assemblies 62. The cables 44 then pass down the moonpool 26, around the support sheaves 64, back up the moonpool and around the other side of the turn-down sheave assemblies 62. From there, the winch cables 44 are fed up and down over the six sheaves in the upper and lower sheave sets 52 and 54 provided on the sides 59 of the rams 46. Finally, the winch cables 44 are fed off the tensioners 38 over horizontal output sheaves 76 to the output winches 60.

In the active compensation mode, the output winches 60 reel-out and pay-in the winch cable 44 through the above arrangement, to thereby lower and raise the tension frame 20 relative to the drillship 10, thus accounting for movement of the vessel relative to the seabed 37. The input winches 50 are fixed and thus locked during this time, such that a working length 78 of the winch cable 44 is utilised during this movement. The input winches 58 may operate in conjunction with the tensioners 38 in order to both enable lowering of the riser string 14 and compensation for movement of the drillship 10 relative to the seabed 37.

After a defined time-period and/or number of cycles of operation, the working length 78 of the winch cable 44 is changed over. This is achieved by paying cable off from the input winches 58 and reeling spent cable onto the output winches 60. It will be understood that this procedure may be carried out during active or passive compensation, by appropriate control of the winches 58 and 60 in view of the required position of the tension frame 20. The tubing support assembly 12 thus provides a system whereby the operating length 78 of the winch cables 44 can be changed over without requiring an operational mode of the assembly 12 to be varied.

In FIGS. 7 and 8, part of a control system 42 for controlling operation of the tensioners 38, input winches 58 and output winches 60 is shown schematically during operation. It will be understood that all the tensioner cylinders 50 are controlled by the system 40, but will be described with reference to a single cylinder 50.

In FIG. 7, the cylinder 50 of one of the ram assemblies 32 is shown, as well as two pressure compensation units 82 and 84. Each pressure compensation unit 82, 84 is fluidly coupled to the cylinder 50. The piston 48 has two opposed piston faces 85, 87 and the compensation units 82, 84 are in fluid communication with the faces 85 and 87, respectively. The compensation unit 82 includes a high pressure compensator 86 of a known type, having a gas-over-liquid bladder structure; in the illustrated embodiment, the compensator 86 has a Nitrogen or air area 88 and an oil area 90. Also, air expansion vessels 91 are coupled via a regulator 93 to a main expansion vessel 95; these permit storage and control of the high pressures generated in use of the tensioners 38. The compensation unit 84 has a compensator 92 of similar structure to compensator 86, with a Nitrogen area 94 and an oil area 96.

In use, when the drillship 10 heaves upwardly, the winch cables 44 urge the tensioner pistons 48 downwardly, expelling fluid from the cylinders 50 into the accumulators 92, as shown in FIG. 7. This compresses and thus pressurises the Nitrogen in the area 88, which is stored through the arrangement of expansion vessels 95 and 91, controlled by regulator 93. Accordingly, the energy of the upward movement of the drillship 10 is retained. When the drillship 10 heaves downwardly, as shown in FIG. 8, the stored pressure in the accumulators 86 drives the pistons 48 upwardly, due to the pressure differential across the piston faces 85, 87. As a result, slack in the winch cables 44 is taken up, to maintain position of the tension frame 20 (and thus the casing string 14). During this movement, fluid is expelled from the cylinders 50 to the accumulators 92 and used to assist piston movement during a return stroke. This process is repeated in cycles, the tensioners 38 effectively acting as hydraulic springs.

In an alternative arrangement shown in FIG. 9, the assembly 12 is provided without the tensioners 38, and the output winches 60 are utilised to compensate for movements of the drillship 10. The control system 40 then includes a pump 98 and valves 104, 106 which supply hydraulic fluid to motors 103 on each winch 60, to rotate the winches 60 clockwise and anti-clockwise as required, thereby raising and lowering the tension frame 20 and thus the string 14 during active compensation. Thus the position of the lower end of the casing riser string 14 relative to the seabed 37 is controlled, within acceptable tolerances.

The pump 98 is coupled to the motor 103 by control lines 100, 102 which also couple accumulators 86 and 92 of compensator units 82, 84 to the motor 103. The accumulators 86 have Nitrogen areas 88 and oil areas 90, whilst the accumulators 92 have Nitrogen areas 94 and oil areas 96. In the passive compensation mode, upward movement of the drillship 10, described above in relation to FIGS. 7 and 8, rotates the winches 60 to thereby expel high pressure fluid from the motors 103 and into the compensators 92. In this fashion, during return movement of the drillship 10, the stored pressure in the compensators 92 is utilised to assist the return movement. In FIG. 9, the control system 40 is shown following a movement where fluid has been charged to the compensators 92, but it will be understood that during the opposite piston movement, fluid is charged to the lower pressure compensators 86. In this fashion, power usage of the support assembly 12 during passive compensation is reduced.

From the above description of the tubing support assembly 12, it will be evident that a system is provided where accurate control of the position of the casing riser string 14 relative to the seabed 37 is achieved, with little or no load supported at height above the deck 22 of the drillship 10. Also, power usage is optimised by the ability to switch between the active and passive compensation modes.

There follows a brief description of a method of running the casing riser string 14 from the drillship 10 following the teachings of PCT/GB2005/002885.

The tubing support assembly 12 operates in distinct phases:

Phase 1: running the conductor casing (lowermost on the string 14), the shut off system of PCT/GB2005/002885 (not shown) and building up the casing riser 14 joint by joint, with load sharing by a drill string compensator (not shown) on the ramrig 30 and the tubing support assembly 12. No compensation is required in this phase, and the cylinders 50 do not need to stroke in and out. This is illustrated in FIGS. 3 to 5. To lower and raise the tension frame 20, the winch cables 44 are paid out and taken up by the output winches 60.

Phase 2: to land the conductor casing, active heave compensation is required. Before landing the casing 14 on the seabed 37, all load transferred to the tubing support assembly, which is switched over to active heave mode. This will involve both the output winches 60 paying out the winch cables 44, and the hydro-pneumatic piston type tensioners 38 actively adjusting the position of the load as it approaches the seabed 37. The entire assembly (including the shut-off system) is lowered on the casing 14 with the conductor and is jetted in the seabed 37. After reaching the required depth, the conductor needs time for settling in the soil. During that period passive mode is applied and the maximum allowable load variation will typically be plus/minus 5 to 10 tons.

Phase 3: disconnect the riser 14 inside the shut-off system and drill with casing riser 14 and a bit (not shown) through the shut-off system to a required depth. During the drilling phase the casing riser 14 is manipulated from the ramrig 30 drill string compensator. Any compensation will be in the passive mode. The tubing support assembly 12 is not required at this phase and the tension and leader frames 20, 66 will be simply suspended in a stationary position.

Phase 4: a near-surface BOP is installed on top of the casing riser 14 and the tubing support assembly 12 is suspending the casing 14 underneath the near-surface BOP. The Near Surface BOP is lowered down through the moonpool 26 on the tension frame 20, supported by the tubing support assembly 12 until it is in the correct position below a keel level of the drillship 10. The casing riser 14 is free to move in and out of the shut-off system in response to vessel heave and other loading. Once the casing 14 is spaced out correctly inside the shut-off system, the casing 14 is gripped and the tubing support assembly 12 now works in passive mode. Slip joints are made up on the rig floor 24 and an injector (not shown) is installed. Drilling is continued through the casing 14 by means of coiled tubing (not shown).

Phase 5: periodically, depending on the load and number of cycles, the winch ropes 44 will be paid off the output winches 60 and taken up on the input (discard) winches 58. If this can be coordinated with the heave of the vessel, it can be done with the tubing support assembly 12 under load.

Phase 6: in case an emergency disconnection is required, for example, if the drillship 10 cannot maintain position, the casing riser 14 will be cut inside the shut-off system and an anti recoil device (not shown) avoids uncontrolled recoil of the riser 14, yet still enabling the cylinder pistons 48 to extend until the severed casing riser 14 is three meters above the top of the shut-off device. After that the output winches 60 will further elevate the riser.

Various modifications may be made to the foregoing without departing from the spirit and scope of the present invention.

1. A tubing support assembly for a vessel, the tubing support assembly comprising:
a tubing support adapted to receive and support tubing to be deployed from the vessel, the tubing support being movable relative to the vessel deck and adapted to be located below a level of the vessel deck, to facilitate deployment of the tubing from the vessel.

2. An assembly as claimed in claim 1, wherein the tubing support is adapted to be located below a rig floor of the vessel.

3. An assembly as claimed in claim 1, wherein the tubing support assembly is a tubing tensioner assembly, for supporting the tubing and placing the tubing under tension.

4. An assembly as claimed in claim 1, wherein the tubing support is movable relative to the vessel deck within a passage extending through the vessel deck.

5. An assembly as claimed in claim 4, wherein the tubing support is movable within a moonpool of the vessel.

6. An assembly as claimed in claim 4, wherein the tubing support is mounted for movement through the passage, and is movable between a position within the passage and a position outside the passage, to facilitate deployment of the tubing.

7. An assembly as claimed in claim 1, wherein the tubing support is adapted to be moved to a position where the support is submerged.

8. An assembly as claimed in claim 1, wherein the assembly is adapted to compensate for relative movement between the vessel and the tubing.

9. An assembly as claimed in claim 1, wherein the assembly is adapted to be operated in an active compensation mode where the tubing is raised and lowered relative to the vessel by the tubing support, in order to control movement of the tubing relative to the seabed.

10. An assembly as claimed in claim 9, wherein the assembly is adapted to be operated in the active compensation mode prior to location of the tubing in the seabed.

11. An assembly as claimed in claim 1, wherein the tubing support is adapted to be raised and lowered relative to the vessel in order to compensate for relative movement between the vessel and the tubing.

12. An assembly as claimed in claim 1, wherein the assembly is adapted to be operated in a passive compensation mode, where movement of the vessel relative to the seabed is compensated for by permitting relative movement between the vessel and the tubing.

13. An assembly as claimed in claim 12, wherein the assembly is adapted to be operated in the passive compensation mode following location of the tubing in the seabed.

14. An assembly as claimed in claim 1, wherein the tubing support is adapted to releasably engage and support the tubing.

15. An assembly as claimed in claim 14, wherein the tubing support is a primary tubing support, and wherein the assembly comprises a secondary tubing support which is adapted to selectively support the tubing to facilitate deployment of the tubing from the vessel.

16. An assembly as claimed in claim 15, wherein the secondary tubing support is provided on the vessel deck and is adapted to support the tubing when the primary tubing support is released from the tubing.

17. An assembly as claimed in claim 1, wherein the tubing support comprises a tubing support device for receiving and supporting the tubing, and wherein the tubing support device is adapted to releasably engage the tubing.

18. An assembly as claimed in claim 1, comprising a support structure having a further tubing support, the support structure adapted to be provided on the vessel deck.

19. An assembly as claimed in claim 18, wherein the further tubing support is adapted to support a part of the load of the tubing, to assist in make-up and deployment of the tubing from the vessel.

20. An assembly as claimed in claim 18, wherein the support structure is a derrick and the further tubing support is an elevator provided on the derrick.

21. An assembly as claimed in claim 18, wherein the support structure is a ramrig and the further tubing support is a travelling yoke of the ramrig.

22. An assembly as claimed in claim 18, wherein the tubing support assembly is adapted to selectively share the load of the tubing between the tubing support and the further tubing support on the support structure.

23. An assembly as claimed in claim 22, wherein the further tubing support is adapted to bear up to 10% of the total load of the tubing.

24. An assembly as claimed in claim 1, comprising a tubing support control system, for controlling movement of the tubing support relative to the vessel deck.

25. An assembly as claimed in claim 24, wherein the assembly is adapted to be operated in an active compensation mode where the tubing is raised and lowered relative to the vessel by the tubing support, in order to control movement of the tubing relative to the seabed, and wherein in the active mode, the control system is adapted to control raising and lowering of the tubing support relative to the vessel deck.

26. An assembly as claimed in claim 24, wherein the control system comprises at least one winch coupled to the tubing support by a winch cable, for raising and lowering the tubing support relative to the vessel deck.

27. An assembly as claimed in claim 26, wherein the at least one winch carries an operative length of winch cable, the operative length being determined by the maximum desired spacing of the tubing support relative to the vessel deck.

28. An assembly as claimed in claim 27, wherein the winch carries sufficient cable to permit changeover of the operative length following at least one of a) a determined number of cycles of reeling and unreeling of the winch cable and b) a determined period of operation using the operative length of cable.

29. An assembly as claimed in claim 28, wherein the tubing support assembly comprises at least one input winch for feeding additional cable and an output winch for receiving spent cable during changeover of the operative length of the winch cable.

30. An assembly as claimed in claim 29, wherein the output winch is adapted to control movement of the tubing support, and is therefore adapted to raise and lower the tubing support.

31. An assembly as claimed in claim 29, wherein the input and output winches are adapted to together control movement of the tubing support.

32. An assembly as claimed in claim 1, comprising at least one tubing tensioning device for accommodating movement of the vessel relative to the seabed.

33. An assembly as claimed in claim 32, wherein the assembly is adapted to be operated in a passive compensation mode where movement of the vessel relative to the seabed is compensated for by permitting relative movement between the vessel and the tubing and wherein in the passive compensation mode, the at least one tubing tensioning device is activated and thereby compensates for movement of the vessel relative to the seabed.

34. An assembly as claimed in claim 32, wherein the at least one tubing tensioning device is adapted to maintain tension in the tubing substantially constant.

35. An assembly as claimed in claim 32, comprising a tubing support control system for controlling movement of the tubing support relative to the vessel deck, the control system comprising at least one winch coupled to the tubing support by a winch cable, for raising and lowering the tubing support relative to the vessel deck; and wherein the assembly is adapted to be operated in an active compensation mode where the tubing is raised and lowered relative to the vessel by the tubing support, in order to control movement of the tubing relative to the seabed; and further wherein in the active compensation mode, the at least one tubing tensioning device is activated, and compensates for movement of the vessel relative to the seabed in conjunction with the at least one winch.

36. An assembly as claimed in claim 32, wherein the at least one tubing tensioning device is fluid actuated.

37. An assembly as claimed in claim 36, wherein the control system comprises at least one winch coupled to the tubing support by a winch cable, for raising and lowering the tubing support relative to the vessel deck, and wherein the winch cable extends from the winch to the tubing tensioning device and from the tubing tensioning device to the tubing support.

38. An assembly as claimed in claim 32, wherein the at least one tubing tensioning device is extendable and adapted to take-up and pay-out winch cable in order to accommodate movement of the tubing support.

39. An assembly as claimed in claim 32, wherein the at least one tubing tensioning device comprises a piston mounted in a cylinder, and wherein the winch cable extends around a first sheave provided on one of the cylinder and the piston and around at least one further second sheave provided on the other one of the cylinder and the piston.

40. An assembly as claimed in claim 39, comprising first and second opposed piston faces, and wherein movement of the piston within the cylinder is achieved by controlling the pressure of fluid that the first and second piston faces are exposed to.

41. An assembly as claimed in claim 40, comprising a first pressure accumulator coupled to the cylinder and associated with the first piston face, and a second pressure accumulator coupled to the cylinder and associated with the second piston face and wherein, in use, the piston is moved by creating a pressure differential across the piston, by exposing one of the piston faces to an elevated fluid pressure relative to the pressure of fluid that the other piston face is exposed to, in response to a movement of the vessel relative to the tubing, and wherein fluid expelled from the cylinder is stored in the respective accumulator.

42. An assembly as claimed in claim 29, wherein in the passive compensation mode, the winch is adapted to be utilised to compensate for movement of the vessel relative to the seabed.

43. An assembly as claimed in claim 42, comprising a fluid driven motor, and a hydraulic control device for controlling the flow of fluid to and thus operation of the motor, for rotating and driving the winch in the passive compensation mode.

44. An assembly as claimed in claim 4, wherein the tubing support comprises a frame in which the tubing is received, and wherein the assembly comprises a guide for guiding a winch cable coupled to the frame, for preventing the cable from coming into contact with a wall of the passage when the tubing support is moved to a position outside the passage.

45. An assembly as claimed in claim 44, wherein the guide is adapted to be located towards a lower end of the passage, and comprises at least one locking member for locking the guide at said location.

46. A vessel comprising:
a vessel deck; and
a tubing support assembly, the tubing support assembly comprising a tubing support adapted to receive and support tubing to be deployed from the vessel through the vessel deck, the tubing support being movable relative to the vessel deck and adapted to be located below a level of the vessel deck, to facilitate deployment of the tubing from the vessel.

47. (canceled)

48. A method of deploying tubing from a vessel, the method comprising the steps of:
supporting tubing to be deployed from the vessel on a tubing support of a tubing support assembly; and
moving the tubing support relative to a deck of the vessel to a location below a level of the vessel deck, to thereby deploy the tubing from the vessel through the vessel deck.
